(19) United States
(12) Patent Application Publication
(10) Pub. No.: US 2015/0303020 A1
(43) Pub. Date: Oct. 22, 2015

(54) METHOD FOR MAKING SHEET-SHAPED HEAT AND LIGHT SOURCE AND METHOD FOR HEATING OBJECT ADOPTING THE SAME

(71) Applicants: Tsinghua University, Beijing (CN); HON HAI PRECISION INDUSTRY CO., LTD., New Taipei (TW)

(72) Inventors: CHANG-HONG LIU, Beijing (CN); SHOU-SHAN FAN, Beijing (CN)

(21) Appl. No.: 14/791,262

(22) Filed: Jul. 3, 2015

Related U.S. Application Data
(63) Continuation of application No. 12/006,302, filed on Dec. 29, 2007.

(30) Foreign Application Priority Data
Oct. 10, 2007 (CN) 200710123813.X

(51) Int. Cl. H01J 9/18; H05B 3/14; H05B 3/00; H05B 3/34

(52) U.S. Cl. CPC H01J 9/18; H05B 3/34; H05B 3/145; H05B 3/009; Y10S 977/742; B82Y 99/00

(57) ABSTRACT

A method of making sheet-shaped heat and light source includes following steps. A raw material of carbon nanotubes is provided. The raw material of carbon nanotubes are added to a solvent to get a floccule structure. The floccule structure is separated from the solvent, and the floccule structure is shaped to obtain a carbon nanotube film. A first electrode and a second electrode are located on a surface or different surfaces of the carbon nanotube film and electrically connected to the carbon nanotube film.

This application is a continuation of U.S. patent application Ser. No. 12/006,302, filed on Dec. 29, 2007, entitled, “SHEET-SHAPED HEAT AND LIGHT SOURCE, METHOD FOR MAKING THE SAME AND METHOD FOR HEATING OBJECT ADOPTING THE SAME”, which claims all benefits accruing under 35 U.S.C. §119 from China Patent Application No. 200710123813.X, filed on Oct. 10, 2007, in the China Intellectual Property Office, the contents of which are hereby incorporated by reference.

### BACKGROUND

1. Field of the Invention

The invention generally relates to sheet-shaped heat and light sources, methods for making the same and methods for heating objects adopting the same and, particularly, to a carbon nanotube based sheet-shaped heat and light source, a method for making the same and a method for heating objects adopting the same.

2. Discussion of Related Art

Carbon nanotubes (CNT) are a novel carbonaceous material and have received a great deal of interest since the early 1990s. It was reported in an article by Sumio Iijima, entitled “Helical Microtubules of Graphitic Carbon” (Nature, Vol. 354, Nov. 7, 1991, pp. 56-58). CNTs are conductors, chemically stable, and capable of having a very small diameter (much less than 100 nanometers) and large aspect ratios (length/diameter). Due to these and other properties, it has been suggested that CNTs should play an important role in various fields, such as field emission devices, new optic materials, sensors, soft ferromagnetic materials, etc. Moreover, due to CNTs having excellent electrical conductivity, thermal stability, and light emitting property similar to black/blackbody radiation, carbon nanotubes can also, advantageously, be used in the field of heat and light sources.

A carbon nanotube yarn drawn from an array of carbon nanotubes and affixed with two electrodes, emits light, when a voltage is applied across the electrodes. The electrical resistance of the carbon nanotube yarn does not increase as much, as metallic light filaments, with increasing temperature. Accordingly, power consumption, of the carbon nanotube yarn, is low at incandescent operating temperatures. However, carbon nanotube yarn is a linear heat and light source, and therefore, difficult to use in a sheet-shaped heat and light source.

Non-linear sheet-shaped heat and light source, generally, includes a quartz glass shell, two or more tungsten filaments or at least one tungsten sheet, a supporting ring, sealing parts, and a base. Two ends of each tungsten filament are connected to the supporting ring. In order to form a planar light emitting surface, the at least two tungsten filaments are disposed parallel to each other. The supporting ring is connected to the sealing parts. The supporting ring and the sealing parts are disposed on the base, thereby, defining a closed space. An inert gas is allowed into the closed space to prevent oxidation of the tungsten filaments. However, they are problems with the sheet-shaped heat and light source: Firstly, because tungsten filaments/sheets are grey-body radiation emitters, the temperature of tungsten filaments/sheets increases slowly, thus, they have a low efficiency of heat radiation. As such, distance of heat radiation transmission is relatively small. Secondly, heat radiation and light radiation are not uniform. Thirdly, tungsten filaments/sheets are difficult to process. Further, during light emission, the tungsten filaments/sheets maybe need a protective work environment.

What is needed, therefore, is a sheet-shaped heat and light source having a large area, uniform heat and light radiation, a method for making the same being simple and easy to be applied, and a method for heating an object adopting the same.

### BRIEF DESCRIPTION OF THE DRAWINGS

Many aspects of the present sheet-shaped heat and light source, the method for making the same, and a method for heating object adopting the same can better be understood with reference to the following drawings.

The components in the drawings are not necessarily to scale, the emphasis instead being placed upon clearly illustrating the principles of the present sheet-shaped heat and light source, the method for making the same, and a method for heating an object adopting the same.

FIG. 1 is a schematic view of a sheet-shaped heat and light source, in accordance with the present embodiment.

FIG. 2 is a cross-sectional schematic view of FIG. 1 along a line II-II′.

FIG. 3 is a flow chart of a method for making the sheet-shaped heat and light source shown in FIG. 1.

FIG. 4 shows a Scanning Electron Microscope (SEM) image of a flocculated structure of carbon nanotubes formed by the method of FIG. 3, and

FIG. 5 shows a Scanning Electron Microscope (SEM) image of a carbon nanotube film formed by the method of FIG. 3 wherein the carbon nanotube film has a predetermined shape.

FIG. 6 is a schematic view of heating an object using the sheet-shaped heat and light source shown in FIG. 1.

FIG. 7 is a cross-sectional schematic view of FIG. 6 along a line VII-VII′.

Corresponding reference characters indicate corresponding parts throughout the several views. The exemplifications set out herein illustrate at least one present embodiment of the sheet-shaped heat and light source, the method for making the same, and a method for heating object adopting the same, in at least one form, and such exemplifications are not to be construed as limiting the scope of the invention in any manner.

### DETAILED DESCRIPTION OF PREFERRED EMBODIMENTS

Reference will now be made to the drawings, in detail, to describe embodiments of the sheet-shaped heat and light source, the method for making the same, and a method for heating an object adopting the same.

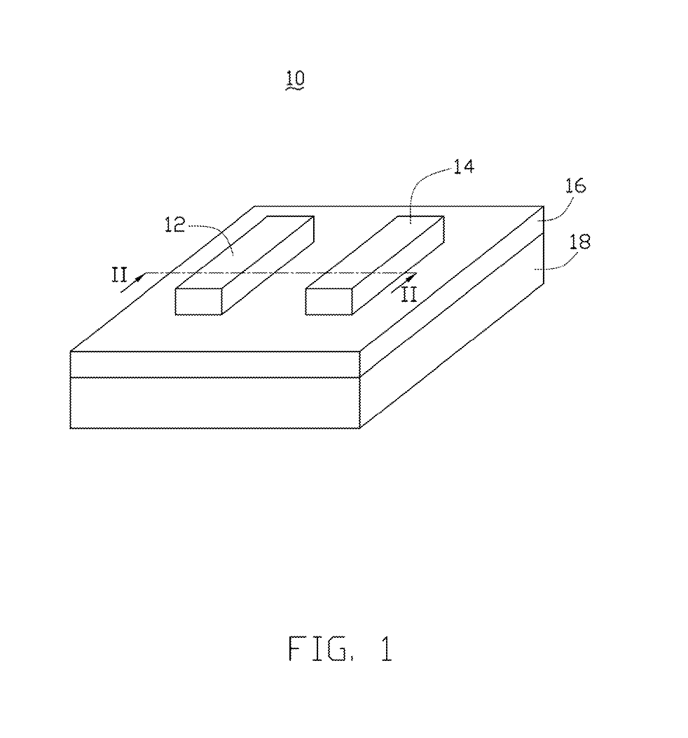

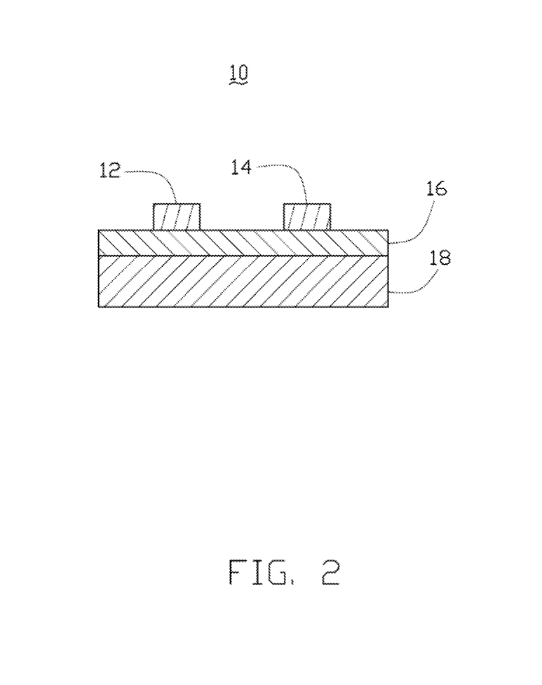

Referring to FIGS. 1 and 2, a sheet-shaped heat and light source 10 is provided in the present embodiment. The sheet-shaped heat and light source 10 includes a first electrode 12, a second electrode 14, a carbon nanotube film 16, and a base 18. The first electrode 12 and the second electrode 14 are separately disposed on the carbon nanotube film 16 at a certain distance apart and electrically connected thereto.

Further, the carbon nanotube film 16 includes a plurality of carbon nanotubes entangled with each other. The adjacent carbon nanotubes are combined and entangled by van der Waals attractive force, thereby forming an entangled structure/microporous structure. Further, the carbon nanotubes in the carbon nanotube film 16 are isotropic. It is understood that the carbon nanotube film is very microporous. Sizes of the micropores are less than 50 micrometers. Length and width of the carbon nanotube film 16 are not limited. Due to the carbon nanotube film 16 having good tensile strength, it can, advantageously, be formed into almost any desired shape. As such, the carbon nanotube film can, opportunely, have a planar or curved structure.

In the present embodiment, a thickness of the carbon nanotube film 16 is in an approximate range from 1 micrometer to 2 millimeters. The carbon nanotube film 16 has a planar structure. A length of each carbon nanotube film is about 30 centimeters. A width of each carbon nanotube film is about 30 centimeters. A thickness of each carbon nanotube film is about 1 millimeter.

It is to be understood that, the first electrode 12 and the second electrode 14 can, opportunely, be disposed on a same surface or opposite surfaces of the carbon nanotube film 16. Further, it is imperative that the first electrode 12 and the second electrode 14 are separated by a certain distance to form a certain resistance therebetween, thereby preventing short circuiting of the electrodes. In the present embodiment, because of the adhesive properties of the carbon nanotube film, the first electrode 12 and the second electrode 14 are directly attached to the carbon nanotube film 16 thereby forming an electrical contact therebetween. On the other hand, the first electrode 12 and the second electrode 14 are attached on the same surface of the carbon nanotube film 16 by a conductive adhesive. Quite suitably, the conductive adhesive material is silver adhesive. It should be noted that any other bonding ways may be adopted as long as the first electrode 12 and the second electrode 14 are electrically connected to the carbon nanotube film 16.

The base 18 is selected from the group consisting of ceramic, glass, resin, and quartz. The base 18 is used to support the carbon nanotube film 16. The shape of the base 18 can be determined according to practical needs. In the present embodiment, the base 18 is a ceramic substrate. Due to the freestanding property of the carbon nanotube film 16, the sheet-shaped heat and light source 10 can, benefically, be without the base 18.

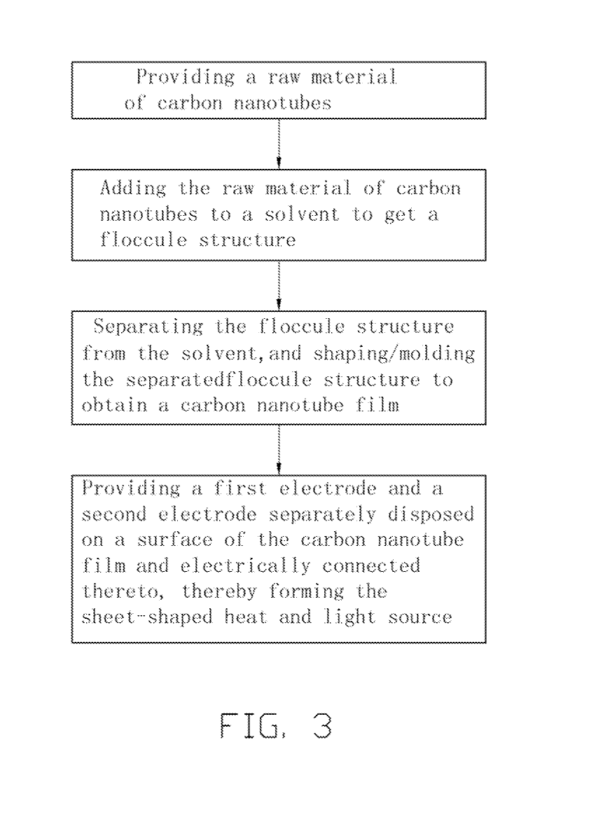

Referring to FIG. 3, a method for making the above-described sheet-shaped heat and light source 10 are provided in the present embodiment. The method includes the steps of: (a) providing a raw material of carbon nanotubes; (b) adding the raw material of carbon nanotubes to a solvent to get a floccule structure; (c) separating the floccule structure from the solvent, and shaping/molding the separated floccule structure to obtain a carbon nanotube film 16; and (d) providing a first electrode and a second electrode separately disposed on a surface or different surfaces of the carbon nanotube film and electrically connected thereto, thereby forming the sheet-shaped heat and light source 10.

In step (a), an array of carbon nanotubes, quite suitably, a super-aligned array of carbon nanotubes is provided. The given super-aligned array of carbon nanotubes can be formed by the steps of: (a1) providing a substantially flat and smooth substrate; (a2) forming a catalyst layer on the substrate; (a3) annealing the substrate with the catalyst layer in air at a temperature in the approximate range from 700° C. to 900° C. for about 30 to 90 minutes; (a4) heating the substrate with the catalyst layer to a temperature in the approximate range from 500° C. to 740° C. in a furnace with a protective gas therein; (a5) supplying a carbon source gas to the furnace for about 5 to 30 minutes and growing a super-aligned array of carbon nanotubes on the substrate; and (a6) separating the array of carbon nanotubes from the substrate to get the raw material of carbon nanotubes.

In step (a1), the substrate can, beneficially, be a P-type silicon wafer, an N-type silicon wafer, or a silicon wafer with a film of silicon dioxide thereon. Preferably, a 4-inch P-type silicon wafer is used as the substrate.

In step (a2), the catalyst can, advantageously, be made of iron (Fe), cobalt (Co), nickel (Ni), or any alloy thereof.

In step (a4), the protective gas can, beneficially, be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can, opportunely, have a height above 100 microns and include a plurality of carbon nanotubes parallel to each other and approximately perpendicular to the substrate. Because the length of the carbon nanotubes is very long, portions of the carbon nanotubes are bundled together. Moreover, the super-aligned array of carbon nanotubes formed under the above conditions is essentially free of impurities such as carbonaceous or residual catalyst particles. The carbon nanotubes in the super-aligned array are closely packed together by the van der Waals attractive force.

In step (a6), the array of carbon nanotubes is scraped from the substrate by a knife or other similar devices to obtain the raw material of carbon nanotubes. Such a raw material is, to a certain degree, able to maintain the bundled state of the carbon nanotubes. The length of the carbon nanotubes in the raw material is above 10 micrometers.

In step (b), the solvent is selected from the group consisting of water and volatile organic solvent. After adding the raw material of carbon nanotubes to the solvent, a process of flocculating is executed to get the floccule structure. The process of flocculating is selected from the group of processes consisting of ultrasonic dispersion and high-strength agitating/vibrating. Quite usefully, in this embodiment ultrasonic dispersion is used to flocculate the solvent containing the carbon nanotubes for about 10˜30 minutes. Due to the carbon nanotubes in the solvent having a large specific surface area and the bundled carbon nanotubes having a large van der Waals attractive force, the flocculated and bundled carbon nanotubes form an entangled structure (i.e., floccule structure).

In step (c), the process of separating the floccule structure from the solvent includes the substeps of: (c1) pouring the solvent containing the floccule structure through a filter into a funnel; and (c2) drying the floccule structure on the filter to obtain the separated floccule structure of carbon nanotubes.

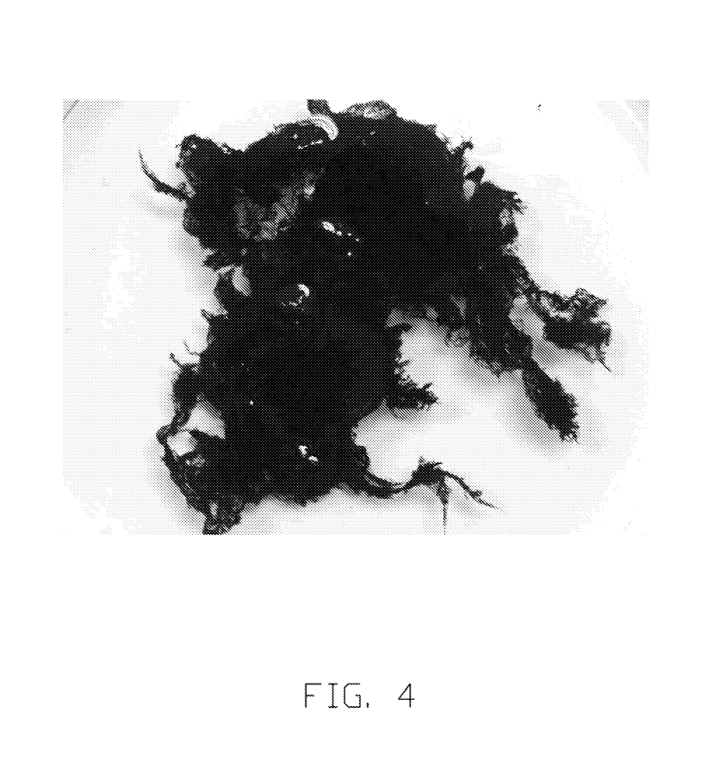

In step (c2), a time of drying can be selected according to practical needs. Referring to FIG. 4, the floccule structure of carbon nanotubes on the filter is bundled together, so as to form an irregular flocculate structure.

In step (c), the process of shaping/molding includes the substeps of: (c3) putting the separated floccule structure into a container (not shown), and spreading the floccule structure to form a predetermined structure; (c4) pressing the spread floccule structure with a certain pressure to yield a desirable shape; and (c5) drying the spread floccule structure to remove the residual solvent or volatilizing the residual solvent to form a carbon nanotube film.

It is to be understood that the size of the spread floccule structure is, advantageously, used to control a thickness and a surface density of the carbon nanotube film. As such, the larger the area of a given amount of the floccule structure is spread over, the less the thickness and the density of the carbon nanotube film.

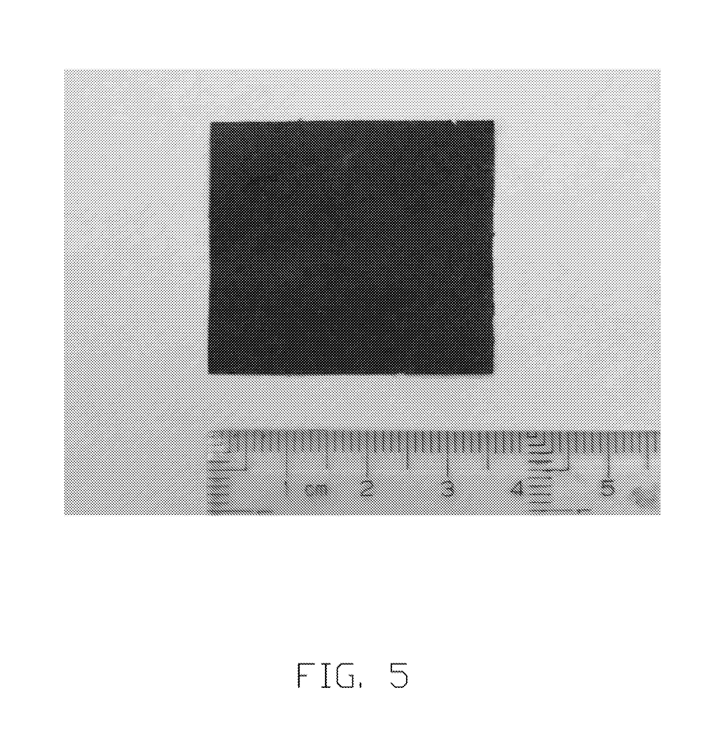

Referring to FIG. 5, bundling of the carbon nanotubes in the carbon nanotube film, provides strength to the carbon nanotube film. Also because of the flexibility of the carbon nanotube film, the carbon nanotube film can easily be folded or bent into arbitrary shapes without rupture. In the embodiment, the thickness of the carbon nanotube film 16 is in the approximate range from 1 micrometer to 2 millimeters, and the width of the carbon nanotube film 16 is in the approximate range from 1 millimeter to 10 millimeters.

Further, the step (c) can be accomplished by a process of pumping filtration to obtain the carbon nanotube film 16. The process of pumping filtration includes the substeps of: (c1′) providing a microporous membrane and an air-pumping funnel; (c2′) filtering the solvent containing the floccule structure of carbon nanotubes through the microporous membrane into the air-pumping funnel; and (c3′) air-pumping and drying the floccule structure of carbon nanotubes captured on the microporous membrane.

In step (c1′), the microporous membrane has a smooth surface. And the diameters of micropores in the membrane are about 0.22 microns. The pumping filtration can exert air pressure on the floccule structure, thus, forming a uniform carbon nanotube film. Moreover, due to the microporous membrane having a smooth surface, the carbon nanotube film can, beneficially, be easily separated from the membrane.

The carbon nanotube film 16 produced by the method has the following virtues. Firstly, through flocculating, the carbon nanotubes are bundled together by van der Walls attractive force to form an entangled structure/floccule structure. Thus, the carbon nanotube film 16 is very durable. Secondly, the carbon nanotube film 16 is very simply and efficiently produced by the method. A result of the production process of the method, is that thickness and surface density of the carbon nanotube film are controllable.

In practical use, the carbon nanotube film 16 can, beneficially, be disposed on a base 18. The base 18 is selected from the group consisting of ceramic, glass, resin, and quartz. The base 18 is used to support the carbon nanotube film 16. The shape of the base 18 can be determined according to practical needs. In the present embodiment, the base 18 is a ceramic substrate. Moreover, due to the carbon nanotube film 16 having a free-standing property, in practice, the carbon nanotube films can, benefically, be disposed on a frame, thereby forming the carbon nanotube film 16. After that, the frame can be taken out. Accordingly, the carbon nanotube film 16 can, opportunely, be used in the sheet-shaped heat and light source 10 without the base 18.

In a process of using the sheet-shaped heat and light source 10, when a voltage is applied to the first electrode 12 and the second electrode 14, the carbon nanotube film 16 of the sheet-shaped heat and light source 10 emits electromagnetic waves with a certain wavelength. Quite suitably, when the carbon nanotube film 16 of the sheet-shaped heat and light source 10 has a fixed surface area (length*width), the voltage and the thickness of the carbon nanotube film 16 can, opportunely, be used to make the carbon nanotube film 16 emit electromagnetic waves at different wavelengths. If the voltage is fixed at a certain value, the electromagnetic waves emitting from the carbon nanotube film 16 are inversely proportional to the thickness of the carbon nanotube film 16. That is, the greater the thickness of carbon nanotube film 16, the shorter the wavelength of the electromagnetic waves. Further, if the thickness of the carbon nanotube film 16 is fixed at a certain value, the greater the voltage applied to the electrode, the shorter the wavelength of the electromagnetic waves. As such, the sheet-shaped heat and light source 10, can easily be configured to emit a visible light and create general thermal radiation or emit infrared radiation.

As such, due to carbon nanotubes having an ideal black body structure, the carbon nanotube film 16 has excellent electrical conductivity, thermal stability, and high thermal radiation efficiency. The sheet-shaped heat and light source 10 can, advantageously, be safely exposed, while working, to oxidizing gases in a typical environment. When a voltage of 10 volts˜30 volts is applied to the electrodes, the sheet-shaped heat and light source 10 emits electromagnetic waves. At the same time, the temperature of sheet-shaped heat and light source 10 is in the approximate range from 50° C. to 500° C.

In the present embodiment, the surface area of the carbon nanotube film 16 is 900 square centimeters. Specifically, both the length and the width of the carbon nanotube film 16 are 30 centimeters. The carbon nanotube film 16 includes a plurality of carbon nanotubes entangled with each other.

Further, quite suitably, the sheet-shaped heat and light source 10 is disposed in a vacuum device or a device with inert gas filled therein. When the voltage is increased in the approximate range from 80 volts to 150 volts, the sheet-shaped heat and light source 10 emits electromagnetic waves such as visible light (i.e. red light, yellow light etc), general thermal radiation, and ultraviolet radiation.

It is to be noted that the sheet-shaped heat and light source 10 can, beneficially, be used as electric heaters, infrared therapy devices, electric radiators, and other related devices. Moreover, the sheet-shaped heat and light source 10 can, beneficially, be used as an optical device, and thereby being used as light sources, displays, and other related devices.

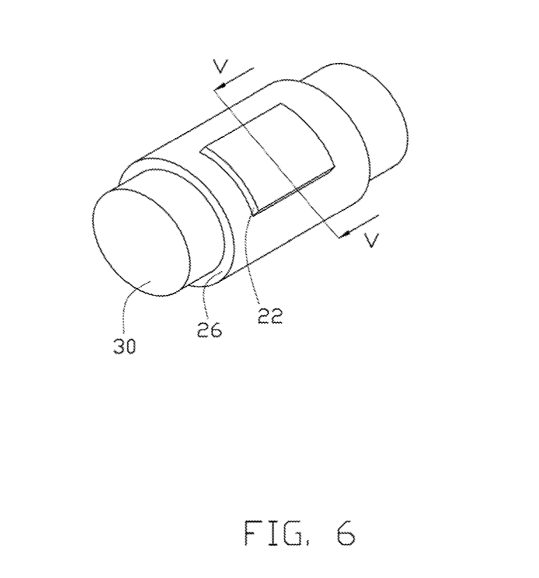

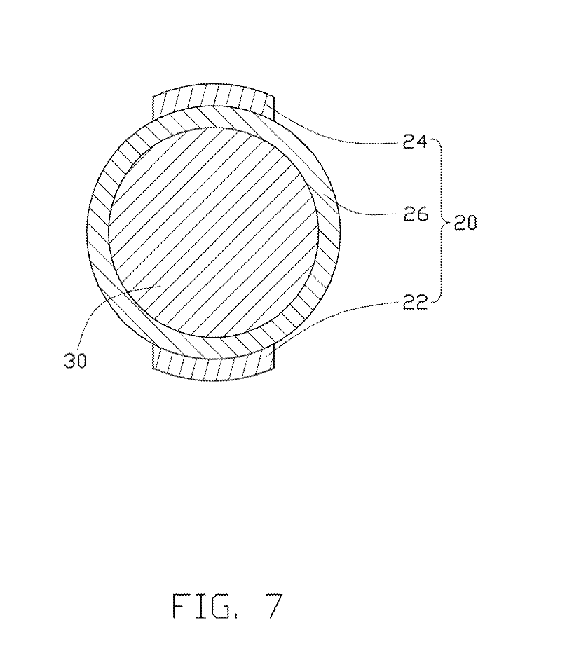

Referring to FIGS. 6 and 7, a method for heating an object adopting the above-described sheet-shaped heat and light source 20 is also described. In the present embodiment, the sheet-shaped heat and light source 20 includes a first electrode 22, a second electrode 24, and a carbon nanotube film 26. Further, the first electrode 24 and the second electrode 26 are separately disposed on the carbon nanotube film 26 at a certain distance apart and electrically connected thereto.

Further, the surface area of the carbon nanotube film 26 is 900 square centimeters. Specifically, both the length and the width of the carbon nanotube film 26 are 30 centimeters. The carbon nanotube film 16 includes a plurality of carbon nanotubes entangled with each other. The voltage applied to the electrode 12 and the electrode 14 is 15 volts. The temperature of the sheet-shaped heat and light source 10 is about 300° C.

Due to the carbon nanotube film 26 having a free-standing property, the sheet-shaped heat and light source 20 can be without a base. Because the carbon nanotube film 26 has excellent tensile strength, the sheet-shaped heat and light source 10 has advantageously a ring-shaped carbon nanotube film 26. Quite suitably, in the process of heating the object 30, the object 30 and the carbon nanotube film 26 may be in direct contact with each other or may be separate from each other, at a certain distance, as required.

The method for heating an object using the sheet-shaped heat and light source 20 includes the steps of: providing an object 30; disposing a carbon nanotube layer 26 of the sheet-shaped heat and light source 20 to a surface of the object 30; and applying a voltage between the first electrode 22 and the second electrode 24 to heat the object 30.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for making a sheet-shaped heat and light source, the method comprising:
(a) providing a raw material of carbon nanotubes;
(b) adding the raw material of carbon nanotubes to a solvent to get a floccule structure;
(c) separating the floccule structure from the solvent, and shaping the floccule structure to obtain a carbon nanotube film;
(d) providing a first electrode and a second electrode electrically connected to the carbon nanotube film, wherein the first electrode and the second electrode are spaced from each other.

2. The method of claim 1, wherein in step (b), after adding the raw material of carbon nanotubes to the solvent, a process of flocculating is executed to get the floccule structure; and the process of flocculating is selected from the group of processes consisting of ultrasonic dispersion and high-strength agitating.

3. The method of claim 1, wherein in step (c), the separating the floccule structure from the solvent is executed by the substeps of:
(c1) pouring the solvent containing the floccule structure of carbon nanotubes through a filter; and
(c2) drying the floccule structure of carbon nanotubes captured on the filter to obtain the separated floccule structure of carbon nanotubes.

4. The method of claim 1, wherein in step (c), the shaping the separated floccule structure is executed by the substeps of:
(c3) putting the separated floccule structure into a container, and spreading the floccule structure to form a predetermined structure;
(c4) pressing the spread floccule structure to yield a desired shape; and
(c5) drying the spread floccule structure to remove the solvent or volatilizing the solvent to form the carbon nanotube film.

5. The method of claim 4, the step (c5) further comprising a process of pumping filtration to obtain the carbon nanotube film, wherein the process of pumping filtration comprises the substeps of:
(c1′) providing a microporous membrane and an air-pumping funnel;
(c2′) filtering the solvent containing the floccule structure of carbon nanotubes through the microporous membrane into the air-pumping funnel; and
(c3′) air-pumping and drying the floccule structure of carbon nanotubes captured by the microporous membrane.

6. The method of claim 1, wherein in step (c), a base is further provided, and the carbon nanotube film is disposed on the base.

7. The method of claim 1, wherein in step (d), the first electrode and the second electrode are attached on the carbon nanotube film by a conductive adhesive.

8. The method of claim 7, wherein the conductive adhesive is silver adhesive.

9. The method of claim 1, wherein a thickness of the carbon nanotube film is in an approximate range from 1 micrometer to 2 millimeters, and a length of each of the raw material of carbon nanotubes is above 10 micrometers.

10. The method of claim 1, wherein the carbon nanotube film is a free-standing structure.

11. The method of claim 10, wherein the adjacent two of the raw material of carbon nanotubes in the carbon nanotube film are combined and entangled by van der Waals force to a microporous structure.

12. The method of claim 11, wherein the microporous structure defines a plurality of micropores, and sizes of the plurality of micropores are less than 50 micrometers.

13. The method of claim 1, wherein the raw material of carbon nanotubes in the carbon nanotube film are isotropic.

14. The method of claim 1, wherein the sheet-shaped heat and light source is planar or curved.

15. The method of claim 1, further comprising a step of curving the carbon nanotube film into a hollow cylinder.

16. The method of claim 15, wherein the first electrode and the second electrode extend along a length direction of the hollow cylinder.

17. A method for making a sheet-shaped heat and light source, the method comprising:
providing a plurality of carbon nanotubes;
getting a flocuule structure by adding the plurality of carbon nanotubes into a solvent and flocculating the plurality of carbon nanotubes in the solvent, wherein the plurality of carbon nanotubes are entangled together;
separating the floccule structure from the solvent;
obtaining a carbon nanotube film by shaping the floccule structure; and
applying a first electrode and a second electrode electrically connected to the carbon nanotube film, wherein the first electrode and the second electrode are spaced from each other.

18. The method of claim 17, wherein the floccule structure is shaped into a hollow cylinder.

19. A method for heating an object by a sheet-shaped heat and light source, the method comprising: providing an object; disposing a carbon nanotube film of the sheet-shaped heat and light source to a surface of the object, the carbon nanotube film comprises a plurality of carbon nanotubes entangled with each other, and is connected to the object; and applying a voltage between at least two electrodes of the sheet-shaped heat and light source to heat the object.
